(19) United States
(12) Patent Application Publication
(10) Pub. No.: US 2026/0030835 A1
(43) Pub. Date: Jan. 29, 2026

(54) INFORMATION PROCESSING SYSTEM, INFORMATION PROCESSING METHOD, AND MEDIUM

(71) Applicant: CANON KABUSHIKI KAISHA, Tokyo (JP)

(72) Inventor: Fumihiro KAJIMURA, Kanagawa (JP)

(21) Appl. No.: 19/274,772

(22) Filed: Jul. 21, 2025

(30) Foreign Application Priority Data
Jul. 29, 2024 (JP) 2024-122553

(51) Int. Cl. G06T 15/20; G06T 7/73

(52) U.S. Cl. CPC G06T 15/205; G06T 7/75

(57) ABSTRACT

An information processing system for controlling a virtual camera disposed in a virtual space to generate a virtual viewpoint video is provided. The system obtains a second camera parameter that indicates a position and an orientation of the virtual camera. A first camera parameter is set in advance, stored in a storage, and indicates an orientation of the virtual camera and a position of a gaze point corresponding to the virtual camera. The system performs control for changing the position and orientation of the virtual camera indicated by the second camera parameter based on the second camera parameter and the first camera parameter. The position and orientation of the virtual camera after completion of the change are determined based on the second camera parameter and the first camera parameter.

### BACKGROUND

### Field of the Technology

The present disclosure relates to an information processing system, an information processing method, and a non-transitory computer-readable medium, and particularly relates to designation of a virtual viewpoint for generating a virtual viewpoint image.

### Description of the Related Art

In recent years, systems are proposed for generating a virtual viewpoint video of an image capturing space as viewed from a virtual viewpoint designated by a user based on a plurality of captured images obtained by a plurality of imaging devices in the image capturing space. Japanese Patent Laid-Open No. 2017-211828 discloses a technology for generating such a virtual viewpoint video.

The plurality of captured images obtained by the plurality of imaging devices can be stored in an image processing device such as a server. The virtual viewpoint represents a viewpoint of a virtual camera (hereinafter referred to as “virtual camera”) that can freely move in a three-dimensional space. The image processing device can generate the virtual viewpoint video composed of a plurality of virtual viewpoint images (frames) by rendering the virtual viewpoint images from such a virtual camera. The virtual viewpoint video is displayed on a display device. The user can view the virtual viewpoint video displayed on the display device. The virtual viewpoint can be designated by the producer of the virtual viewpoint video or a viewer of the virtual viewpoint images. Such a virtual viewpoint video technology is used to create videos that are more realistic in sports broadcasting and the like.

### SUMMARY

One embodiment of the present disclosure makes it easy to obtain a desired virtual viewpoint video with simple operations when controlling a virtual camera disposed in a virtual space to generate the virtual viewpoint video.

According to an embodiment, an information processing system for controlling a virtual camera disposed in a virtual space to generate a virtual viewpoint video comprises one or more memories storing instructions and one or more processors that execute the instructions to: obtain a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and perform control for changing the position and orientation of the virtual camera indicated by the second camera parameter based on the second camera parameter and the first camera parameter, wherein the position and orientation of the virtual camera after completion of the change are determined based on the second camera parameter and the first camera parameter.

According to another embodiment, an information processing method for controlling a virtual camera disposed in a virtual space to generate a virtual viewpoint video comprises: obtaining a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and performing control for changing the position and orientation of the virtual camera indicated by the second camera parameter based on the second camera parameter and the first camera parameter, wherein the position and orientation of the virtual camera after completion of the change are determined based on the second camera parameter and the first camera parameter.

According to still another embodiment, a non-transitory computer-readable medium stores a program executable by a computer to perform a method for controlling a virtual camera disposed in a virtual space to generate a virtual viewpoint video, comprising: obtaining a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and performing control for changing the position and orientation of the virtual camera indicated by the second camera parameter based on the second camera parameter and the first camera parameter, wherein the position and orientation of the virtual camera after completion of the change are determined based on the second camera parameter and the first camera parameter.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an overall configuration diagram of an image processing system according to an embodiment.

FIGS. 2A and 2B are diagrams showing a configuration example of an information processing device according to an embodiment.

FIGS. 3A and 3B are diagrams showing an example of registration of preset information.

FIG. 4 is a diagram showing an example of a preset operation.

FIG. 5 is a diagram showing an example of the preset operation.

FIG. 6 is a flowchart of an information processing method according to an embodiment.

FIG. 7 is a diagram showing an example of the preset operation.

FIGS. 8A to 8C are diagrams showing examples of the preset operation.

FIG. 9 is a diagram showing a hardware configuration example of a computer used in an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In order to rapidly move a virtual camera from a current position to a predetermined position, it is possible to register (preset) the position and orientation of the virtual camera in advance. In response to a command for moving the virtual camera to the preset position being input by a user, a camera path indicating the movement of the virtual camera is set such that the virtual camera smoothly moves from the current position of the virtual camera to the preset position. At this time, the camera path is set such that the orientation of the virtual camera smoothly changes from the current orientation of the virtual camera to the preset orientation. Then, the virtual camera moves along the set camera path to the preset position in such a manner as to have the preset orientation. A function for moving the virtual camera so as to be located at a registered position and have a registered orientation as described above is called a preset function. With use of the preset function, it is possible to register a position and an orientation of the virtual camera that are often used. For example, it is possible to register a position and an orientation of the virtual camera from which it is possible to capture images of a subject that are frequently captured, such as images of a baseball base or a soccer goal in sports broadcasting. The use of the preset function makes it easy to move the virtual camera such that such a subject will be included in a captured image, and therefore, it becomes easy to create a virtual viewpoint video of desired play.

The preset function makes it possible to create a virtual viewpoint video of a subject located at a desired position as viewed from the virtual camera located at the preset position and having the preset orientation after the virtual camera is moved. However, the inventor of the present application came to the realization that the user may want to move the virtual camera by using different methods depending on scenes. For example, the user may want to move the virtual camera such that the subject located at the desired position will be included in the video for a longer period of time. Also, the user may want to move the virtual camera such that the subject moving to the desired position will be more likely to be included in the video.

### Image Processing System

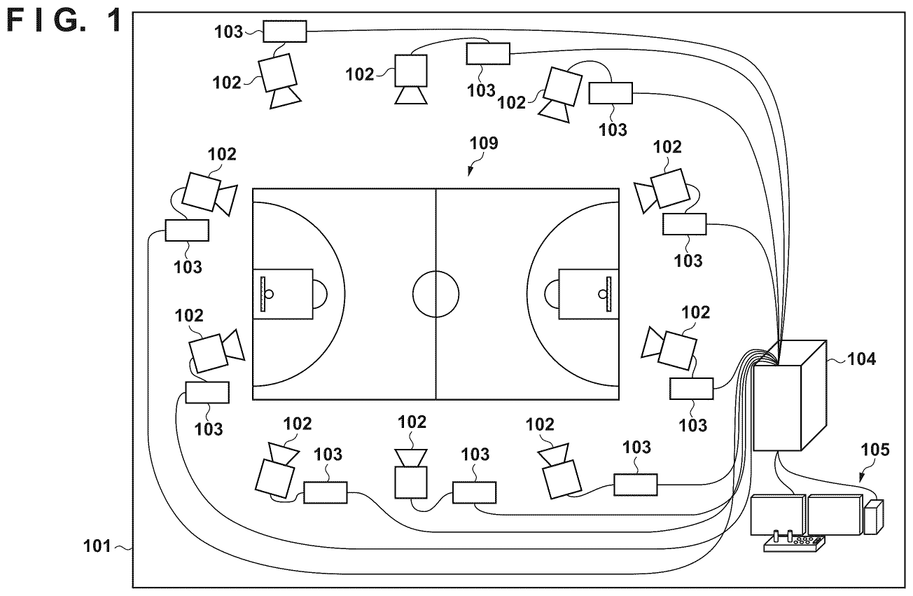

FIG. 1 is a schematic diagram showing an example of an image processing system 101 according to the present disclosure. The image processing system 101 includes a plurality of cameras 102, a plurality of camera control devices 103 respectively connected to the cameras 102, an image processing server 104, and a virtual camera control device 105.

The plurality of cameras 102 are disposed so as to surround an image capturing region 109. The image capturing region 109 defines an image capturing space that is the target of image capturing. One or more subjects may be present in the image capturing region 109. Examples of the subjects include a person such as a player and an object such as a ball.

The camera control devices 103 perform image processing on captured images obtained by the cameras 102 connected to the camera control devices. In the present specification, the image processing performed by the camera control devices 103 will be referred to as “preprocessing”. The preprocessing includes processing for extracting a subject as the foreground from a captured image and generating a silhouette image of the foreground. The silhouette image shows a foreground region in the captured image. The camera control devices 103 transmit the captured images obtained by the cameras 102 and the silhouette images to the image processing server 104.

The image processing server 104 generates a three-dimensional model of the subject based on the captured images obtained by the plurality of cameras 102. For this purpose, the image processing server 104 collects the captured images respectively obtained by the plurality of cameras 102 and the silhouette images obtained based on the captured images. Then, the image processing server 104 generates a virtual viewpoint video based on these images. In the present specification, image processing performed by the image processing server 104 will be referred to as “subsequent processing”. This processing can be performed by a model generating unit 141, which will be described later.

For example, the image processing server 104 generates the three-dimensional model of the subject based on the plurality of silhouette images. The image processing server 104 can generate the 3D model of the subject by applying Visual Hull. In a case where a plurality of subjects are present in the image capturing region 109, the image processing server 104 can generate a three-dimensional model of each of the plurality of subjects. The image processing server 104 stores the generated three-dimensional model of each subject in a model DB 142, which will be described later.

Furthermore, the image processing server 104 generates a virtual viewpoint video of the image capturing space as viewed from a virtual camera. This processing can be performed by a video generating unit 143, which will be described later. For example, the image processing server 104 can perform rendering of a virtual viewpoint video of a three-dimensional model of a subject disposed in a virtual space as viewed from the virtual camera. At this time, the image processing server 104 can dispose three-dimensional models of one or more subjects in the virtual space similarly to the arrangement of the subjects in the image capturing region 109. The arrangement of the subjects in the image capturing region 109 can be determined based on the silhouette images by applying Visual Hull, for example.

The plurality of cameras 102 can capture images of the image capturing region 109 synchronously at each of a plurality of time points. Also, the camera control devices 103 can perform the preprocessing on the images captured at each of the plurality of time points. Then, the image processing server 104 can generate a three-dimensional model of a subject at each of the plurality of time points. A time code can be added to these captured images and the three-dimensional model. The time code to be added may be set based on the time point at which the images are captured. At this time, the image processing server 104 can generate a virtual viewpoint image of the three-dimensional model of the subject at a specific time point as viewed from the virtual camera. The thus generated virtual viewpoint image corresponds to one frame of a virtual viewpoint video. The image processing server 104 can generate the virtual viewpoint video by generating virtual viewpoint images respectively corresponding to the plurality of time points as described above.

The virtual camera control device 105 controls the virtual camera disposed in the virtual space to generate the virtual viewpoint video. The virtual camera control device 105 can set a camera parameter of the virtual camera in accordance with user input as described later. In the present embodiment, the virtual camera control device 105 sets the camera parameter of the virtual camera for each of a plurality of time points. That is to say, the virtual camera control device 105 can control the movement of the virtual camera. A time code can be added to the camera parameter of the virtual camera. At this time, the image processing server 104 can generate a virtual viewpoint image of the three-dimensional model of the subject corresponding to a specific time code as viewed from the virtual camera corresponding to the specific time code.

The virtual camera control device 105 may also be capable of displaying the virtual viewpoint video generated by the image processing server 104. The user can operate the virtual camera via the virtual camera control device 105 while checking the virtual viewpoint video. For example, the user can control the position of the virtual camera. Also, the user can control the direction of the virtual camera by controlling the orientation of the virtual camera.

The image processing system 101 shown in FIG. 1 has a star configuration in which the plurality of camera control devices 103 respectively connected to the cameras 102 are each connected to the image processing server 104. However, the configuration of the image processing system 101 is not limited to this configuration. For example, the image processing system 101 may have a configuration in which the plurality of camera control devices 103 are connected by a daisy chain. In this case, one of the camera control devices 103 can be connected to the image processing server 104. Also, FIG. 1 shows ten cameras 102, but the number of cameras 102 is not particularly limited. Also, the camera control devices 103 need not be separate from the cameras 102. For example, the functions of the camera control devices 103 may also be realized by image processing units included in the cameras 102. Also, the camera control devices 103 may be omitted. In this case, the image processing server 104 can perform both the preprocessing and the subsequent processing.

### Information Processing Device

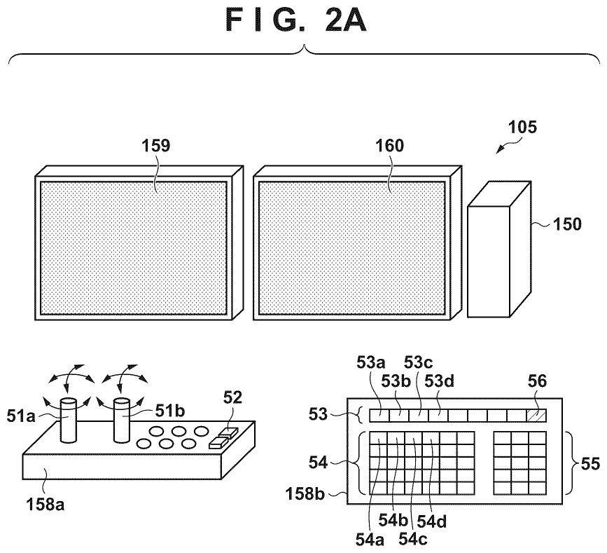

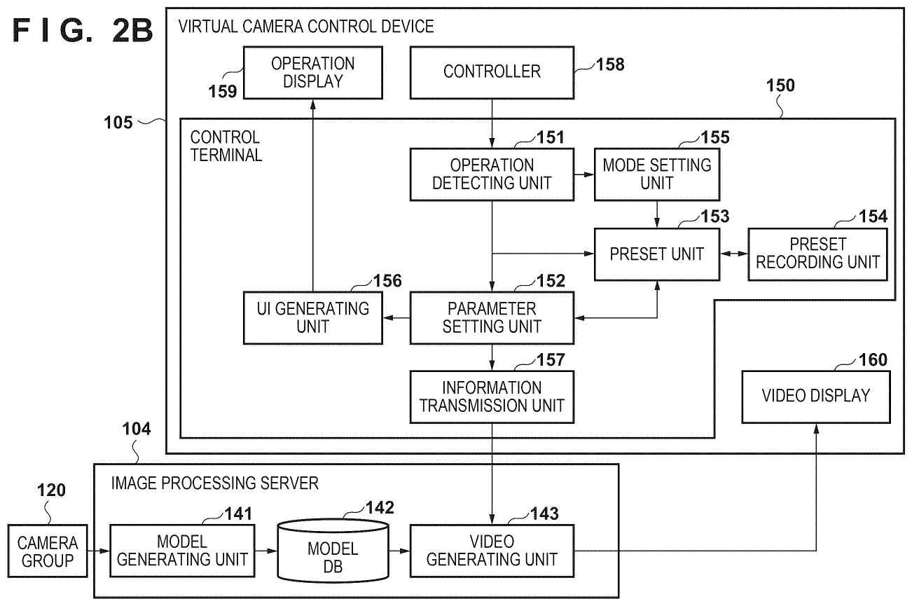

FIG. 2A is a schematic diagram showing an external appearance of the virtual camera control device 105. The virtual camera control device 105 includes a control terminal 150, an operation display 159, a video display 160, and a controller 158. The controller 158 includes an operation controller 158a and a setting controller 158b. The controller 158 is placed in front of the operation display 159 and the video display 160.

The operation controller 158a includes sticks 51a and 51b. The sticks 51a and 51b each have operation axes of three degrees of freedom. By operating the stick 51a, it is possible to cause the virtual camera to make translational motions along X, Y, and Z axes. By operating the stick 51b, it is possible to rotate the virtual camera in the pan, tilt, and roll directions. The operation controller 158a also includes a switch 52. The switch 52 includes a switch having two degrees of freedom. In the example shown in FIG. 2A, the switch 52 is a lever-type zoom switch having two degrees of freedom. By pressing the switch 52 toward a plus side or a minus side, it is possible to change the focal length of the virtual camera. The focal length of the virtual camera may be changeable within a focal length range determined in advance.

The setting controller 158b includes a group of keys for mode setting and a group of keys for preset registration. The group of keys for mode setting includes a plurality of mode keys 53. Each mode key 53 is associated with a specific preset mode. By pressing a mode key 53, it is possible to switch the preset mode to a preset mode corresponding to the pressed mode key 53. FIG. 2A shows mode keys 53a to 53d. The group of keys for preset registration includes a plurality of preset keys 54. Preset information is registered for each preset key 54. In response to a preset key 54 being pressed, the virtual camera is controlled in accordance with the preset information. FIG. 2A shows preset keys 54a to 54d. Details of the preset modes and switching of the preset modes, the preset information and registration of the preset information, and the control of the virtual camera in accordance with the preset information will be described later. The setting controller 158b can also include a group of numeric keys 55 and an entry key 56.

FIG. 2B is a block diagram showing a functional configuration example of the image processing system 101 including the virtual camera control device 105. A camera group 120 includes the plurality of cameras 102 and the camera control devices 103 shown in FIG. 1. The image processing server 104 includes the model generating unit 141, the model DB 142, and the video generating unit 143. The virtual camera control device 105 includes the control terminal 150, the controller 158, the operation display 159, and the video display 160 as described above. The control terminal 150 is an information processing device according to an embodiment of the present disclosure. The control terminal 150 includes an operation detecting unit 151, a parameter setting unit 152, a preset unit 153, a preset recording unit 154, a mode setting unit 155, a UI generating unit 156, and an information transmitting unit 157.

The virtual camera control device 105 is used by the user to operate the virtual camera that is used to generate a virtual viewpoint video. For this purpose, the control terminal 150 can control the virtual camera. Specifically, the control terminal 150 can control camera parameters of the virtual camera at respective time points. In the present embodiment, the term “camera parameter” refers to information indicating a state of the virtual camera. In one embodiment, the camera parameter indicates at least the position and orientation of the virtual camera. For example, the camera parameter can include an external parameter such as the position or orientation of the virtual camera. Also, the camera parameter can include an internal parameter such as the focal length of the virtual camera. Also, the camera parameter may include information that is calculated from an external parameter and an internal parameter, such as the position of a gaze point, which will be described later.

The operation detecting unit 151 obtains user input. In the present embodiment, the operation detecting unit 151 detects operations made on the controller 158 and transmits detection results to the parameter setting unit 152, the mode setting unit 155, and the preset unit 153.

The parameter setting unit 152 sets the camera parameter of the virtual camera. For example, the parameter setting unit 152 can set the camera parameter indicating at least the position and orientation of the virtual camera. In the present embodiment, the camera parameter set by the parameter setting unit 152 includes information of the position, orientation, and focal length of the virtual camera. The parameter setting unit 152 can set the camera parameter based on a detection result of a user operation made on the controller 158.

For example, in a case where the position of the virtual camera is expressed using three-dimensional coordinates (X, Y, Z), the parameter setting unit 152 sets values such as X=4.0, Y=9.0, and Z=1.5. Note that the unit of the coordinates is [m] in the present embodiment. Also, the origin of the coordinates is the center of a 3D model generating region. Also, in a case where the X axis is designated to be parallel to a ground surface, the Y axis is designated to be parallel to the ground surface and perpendicular to the X axis, and the Z axis is designated to be perpendicular to the ground surface.

Also, in a case where the orientation of the virtual camera is expressed using three angles (Pan, Tilt, Roll), the parameter setting unit 152 sets values such as Pan=20.0, Tilt=10.0, and Roll=2.0. Note that the unit of the orientation is [degree] in the present embodiment. Also, the range of each value expressing the orientation is from −180 to 180. Note that Pan represents an angle of rotation parallel to the ground surface, and Tilt represents an angle of rotation perpendicular to the ground surface. Roll represents an angle of rotation about an optical axis of the virtual camera.

Furthermore, the angle of view of the virtual camera can be expressed using the focal length Zoom. In this case, the parameter setting unit 152 can set a value such as Zoom=6.0. Note that the unit of the focal length is [mm] in the present embodiment.

In the present embodiment, the user can directly control the camera parameter such as the position and orientation of the virtual camera via the controller 158. In this case, the parameter setting unit 152 sets the camera parameter of the virtual camera in accordance with user input made via the controller 158. On the other hand, the user can also give an instruction to the control terminal 150 to control the movement of the virtual camera in accordance with preset information as described later. In the present specification, control of the movement of the virtual camera performed based on preset information will be referred to as “preset operation”. In order to perform the preset operation, the parameter setting unit 152 sets the camera parameter of the virtual camera in accordance with a camera path set by the preset unit 153.

With the methods described above, the parameter setting unit 152 can set the camera parameter of the virtual camera corresponding to a specific time point. The information transmitting unit 157 transmits the camera parameter of the virtual camera set by the parameter setting unit 152 to the video generating unit 143. Thereafter, the video generating unit 143 generates a virtual viewpoint image at the specific time point as viewed from a virtual viewpoint indicated by the camera parameter transmitted from the information transmitting unit 157.

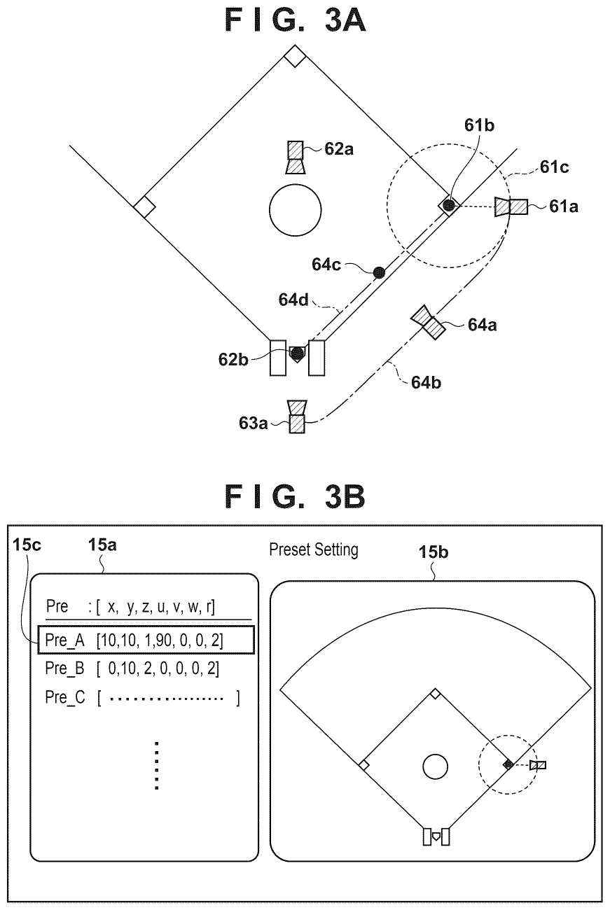

The UI generating unit 156 generates an operation UI that is presented to the user via the operation display 159. The user can check the operation UI displayed on the operation display 159. FIG. 3B shows an example of the operation UI.

The mode setting unit 155 sets a preset mode. In the present embodiment, the operation detecting unit 151 can obtain user input indicating a preset mode that is selected from the plurality of preset modes. The user can operate a mode key 53 included in the setting controller 158b to select the preset mode. The mode setting unit 155 can set the preset mode in response to an operation made on the mode key 53 of the setting controller 158b and detected via the operation detecting unit 151. In the present embodiment, a camera position preset mode is registered for the mode key 53a shown in FIG. 2A, and a camera gaze point preset mode is registered for the mode key 53b shown in FIG. 2A. Moreover, preset modes different from those registered for the mode keys 53a and 53b may also be registered for the mode keys 53c and 53d, respectively. The preset unit 153, which will be described later, can set a camera path in accordance with the preset mode indicated by the user input.

The preset recording unit 154 stores preset information. The preset information indicates a camera parameter (which may also be referred to as a “first camera parameter” in the present specification) that indicates an orientation of the virtual camera and the position of a gaze point corresponding to the virtual camera, which are set in advance. The preset recording unit 154 stores the preset information in association with a preset key 54 as described above. Also, the preset recording unit 154 can store pieces of preset information indicating different positions and orientations of the virtual camera in association with the plurality of preset keys 54, respectively. Note that the preset information may also include information indicating at least the position of the gaze point of the virtual camera or a distance between the virtual camera and the gaze point. Alternatively, the preset information may be information indicating the position and orientation of the virtual camera. As described later, preset information indicating the orientation of the virtual camera, the position of the gaze point, and the distance between the virtual camera and the gaze point can indicate the position and orientation of the virtual camera. Note that types of specific information included in the camera parameter are not specified, as described later. For example, the camera parameter included in the preset information may include information indicating the position and orientation of the virtual camera and the distance between the virtual camera and the gaze point. Such a camera parameter including these types of information can also indicate the orientation of the virtual camera and the position of the gaze point corresponding to the virtual camera.

The preset unit 153 sets a camera path indicating the movement of the virtual camera based on the preset information stored in the preset recording unit 154. As described later, the preset unit 153 can perform control for changing a position and an orientation of the virtual camera that are indicated by a camera parameter (which may also be referred to as a “second camera parameter” in the present specification) different from the first camera parameter. The camera path set by the preset unit 153 can indicate the movement of the virtual camera from the position and orientation indicated by the second camera parameter. That is to say, the second camera parameter can indicate the position and orientation of the virtual camera at the start point of the camera path. For example, the second camera parameter can indicate the current position and orientation of the virtual camera, which have been set. That is to say, the second camera parameter can indicate the position and orientation of the virtual camera at the start of the preset operation or at the time when a preset key 54 is operated. In the following description, the current position and orientation of the virtual camera that have been set and indicated by the second camera parameter will be referred to as a “starting position” and a “starting orientation” of the virtual camera. The camera path can indicate the position and orientation of the virtual camera at each time point. The camera path set by the preset unit 153 may also indicate the camera parameter of the virtual camera at each time point. Here, the preset unit 153 can set the camera path based on the starting position and starting orientation of the virtual camera and the gaze point of the virtual camera disposed in accordance with a camera parameter that is preset in advance.

For example, the preset unit 153 detects an operation made on a preset key 54 included in the setting controller 158b via the operation detecting unit 151. In response to the preset key 54 being pressed, the preset unit 153 reads preset information corresponding to the preset key 54 from the preset recording unit 154. Then, the preset unit 153 sets a camera path based on the starting position and starting orientation of the virtual camera, the read preset information, and the current preset mode. Furthermore, the preset unit 153 transmits the set camera path to the parameter setting unit 152.

The parameter setting unit 152 can set the position and orientation of the virtual camera at each time point in accordance with the camera path. Also, the parameter setting unit 152 can set the camera parameter of the virtual camera at each time point in accordance with the camera path.

In the present embodiment, the virtual camera moves smoothly along the camera path. For example, upper limits may be set for the movement speed and an orientation change speed of the virtual camera. In a case where the virtual camera is moved smoothly as described above, the user can easily recognize the position of the virtual camera that is moving. On the other hand, in this configuration, there is a time lag before the virtual camera reaches the preset position and has the preset orientation as a result of the preset operation.

### Preset Operation

Next, the following describes the preset operation. FIGS. 3A and 3B are diagrams for describing the preset operation and the camera path. In the example shown in FIGS. 3A and 3B, the target of image capturing is a baseball game.

First, the following describes preset registration. FIG. 3A is a schematic diagram for describing the position and orientation of the virtual camera (hereinafter abbreviated as “camera position and orientation”) on a field and preset information. FIG. 3B shows a UI that is displayed on the operation display 159 and is used for preset registration. A number and preset information corresponding to each preset key are displayed in a left display region 15a on the screen shown in FIG. 3B. The field and the position of the virtual camera are displayed in a right display region 15b on the screen.

The user operates the operation controller 158a to move the virtual camera so as to be located at camera position and orientation 61a and face a gaze point 61b as shown in FIG. 3A. Then, in response to the user pressing the entry key 56 and thereafter pressing the preset key 54a, a camera parameter of the virtual camera is registered in the preset recording unit 154 via the preset unit 153. In this example, the camera position and orientation 61a of the virtual camera, the gaze point 61b of the virtual camera, and the radius of a preset spherical surface 61c are registered as Preset A in the preset recording unit 154.

In the present specification, the term “gaze point” refers to the position on which the virtual camera is focused. In one embodiment, the gaze point is a point spaced apart from the virtual camera by a distance corresponding to the focal length indicated by the camera parameter along the direction of line of sight. In this case, the preset unit 153 can determine the gaze point based on the focal length of the virtual camera, the position of the virtual camera, and the orientation of the virtual camera. For example, the gaze point may be a point on the optical axis of the virtual camera. The distance from the virtual camera to the gaze point may be a value determined according to the focal length of the virtual camera. For example, the distance from the virtual camera to the gaze point may be calculated by multiplying the focal length of the virtual camera by a predetermined coefficient. In an example, the distance from the virtual camera to the gaze point corresponding to the focal length can be determined such that, in a virtual viewpoint video, an image of a subject that is present at the gaze point and has a predetermined length in a direction orthogonal to the optical axis has the same length as the length of the virtual viewpoint video in the vertical direction.

In the present embodiment, information of the position and orientation of the virtual camera and the radius of the preset spherical surface is registered as the preset information. The position of the virtual camera indicated by the preset information will be hereinafter referred to as a “preset position”. Also, the orientation of the virtual camera indicated by the preset information will be hereinafter referred to as a “preset orientation”. Hereinafter, the preset position and the preset orientation may also be collectively referred to as “preset position and orientation”. Furthermore, the gaze point of the virtual camera indicated by the first camera parameter indicated by the preset information will be hereinafter referred to as a “preset gaze point”. In the present embodiment, the preset gaze point may be the gaze point of the virtual camera disposed in accordance with the preset information. Also, in the present embodiment, the preset spherical surface is a spherical surface whose center is at the preset gaze point and whose radius is the distance from the preset position to the preset gaze point. The radius of the preset spherical surface can be calculated based on the preset position and the position of the preset gaze point.

The UI shown in FIG. 3B displays the preset information regarding the registered Preset A. In FIG. 3B, the Preset A is selected as a display target as indicated by the highlight 15c in the display region 15a. At this time, the position (x, y, z) and orientation (u, v, w) of the virtual camera at the time when preset registration was performed and the radius (r) of the preset spherical surface are displayed in the display region 15b. Also, the position of the gaze point at the time when preset registration was performed is shown in the display region 15b.

Furthermore, in response to the user pressing the entry key 56 and further pressing another preset key other than the preset key 54a after moving the virtual camera to a suitable position, corresponding preset information can be registered to the other preset key. Also, in response to the preset information being registered, the registered preset information and the name of the corresponding preset key are displayed in the display region 15a. Note that it is also possible to register other preset information for a preset key for which preset information has once been registered.

In the present embodiment, preset information corresponding to camera position and orientation 62a and a gaze point 62b shown in FIG. 3A is registered for the preset key 54b. Also, preset information corresponding to camera position and orientation 63a and the gaze point 62b shown in FIG. 3A is registered for the preset key 54c. Note that FIG. 3A does not show preset spherical surfaces corresponding to the preset keys 54b and 54c. Note that gaze points indicated by pieces of preset information respectively registered for a plurality of preset keys may be the same as each other. For example, the gaze point from the camera position and orientation 62a corresponding to the preset key 54b may be the same as the gaze point from the camera position and orientation 63a corresponding to the preset key 54c.

Note that there is no particular limitation on the method for registering preset information. For example, the user may select the preset position and orientation of the camera on the UI displayed on the operation display 159. Alternatively, the user may directly input each value included in the preset information with use of the numeric keys included in the setting controller 158b.

Next, the following describes an example of the movement of the virtual camera in accordance with preset setting. As described above, the preset unit 153 can set a camera path in accordance with a preset mode selected from the plurality of preset modes. In the present embodiment, the plurality of preset modes include a camera position preset mode and a gaze point preset mode described below. First, the following describes a method for setting a camera path in accordance with the camera position preset mode.

In the camera position preset mode, the preset unit 153 sets a camera path such that the end point of the movement of the virtual camera in accordance with the camera path is a position indicated by a camera parameter of the virtual camera that is preset in advance. At the end point of the movement of the virtual camera in accordance with the camera path, the virtual camera is located at the preset position and has a preset orientation.

Assume that, in FIG. 3A, the current position and orientation of the virtual camera is the camera position and orientation 63a, and the current gaze point of the virtual camera is the gaze point 62b. In response to the preset key 54a being pressed in this state, the virtual camera moves along a camera path shown as a path 64b to the camera position and orientation 61a. In FIG. 3A, camera position and orientation 64a shows a position and an orientation of the virtual camera during its movement. Also, a gaze point 64c shows the gaze point of the virtual camera located at the camera position and orientation 64a. Also, a path 64d shows the movement of the gaze point of the virtual camera while the virtual camera is moving along the path 64b.

As described above, in the present specification, the currently set position and orientation of the virtual camera is referred to as the “starting position and orientation”. Also, the gaze point of the virtual camera indicated by preset information is referred to as the “preset gaze point”. In the example shown in FIG. 3A, the camera position and orientation 63a, which is the position and orientation of the virtual camera at the time when the preset key 54a is pressed, corresponds to the starting position and orientation. Also, the camera position and orientation 61a indicated by the preset information registered for the preset key 54a corresponds to the preset position and orientation. Also, the gaze point 61b of the virtual camera indicated by the preset information registered for the preset key 54a corresponds to the preset gaze point.

In this case, the path 64d of the gaze point of the virtual camera is a straight line connecting the gaze point 62b at the time when the preset key 54a is pressed and the gaze point 61b, which is the preset gaze point. In response to the preset key 54a being pressed, the gaze point of the virtual camera moves along the path 64d at a uniform speed. Also, the virtual camera moves from the position indicated by the camera position and orientation 63a, which is the starting position, to the position indicated by the camera position and orientation 61a, which is the preset position and orientation, at a uniform speed, tracking the moving gaze point. The orientation of the virtual camera during the movement can be controlled according to the position and gaze point of the virtual camera. In a case where the virtual camera is moved smoothly as described above, the user can easily recognize the position of the virtual camera that is moving. Also, it becomes easy to operate the virtual camera after the preset operation.

In another example, the virtual camera may move from the position indicated by the camera position and orientation 63a, which is the starting position and orientation, to the position indicated by the camera position and orientation 61a, which is the preset position and orientation, at a uniform speed along the path 64d. Also, the virtual camera may change its orientation from the orientation indicated by the camera position and orientation 63a, which is the starting position and orientation, to the orientation indicated by the camera position and orientation 61a, which is the preset position and orientation, by rotating at a uniform speed while moving.

In another example, the virtual camera may move at a uniform speed along a straight line connecting the position indicated by the camera position and orientation 63a, which is the starting position and orientation, to the position indicated by the camera position and orientation 61a, which is the preset position and orientation. In this case as well, the virtual camera can change its orientation by rotating at a uniform speed while moving. As described above, in the camera position preset mode, the virtual camera is located at the preset position and has the preset orientation at the end point of the camera path. On the other hand, there is no particular limitation on the movement path of the virtual camera.

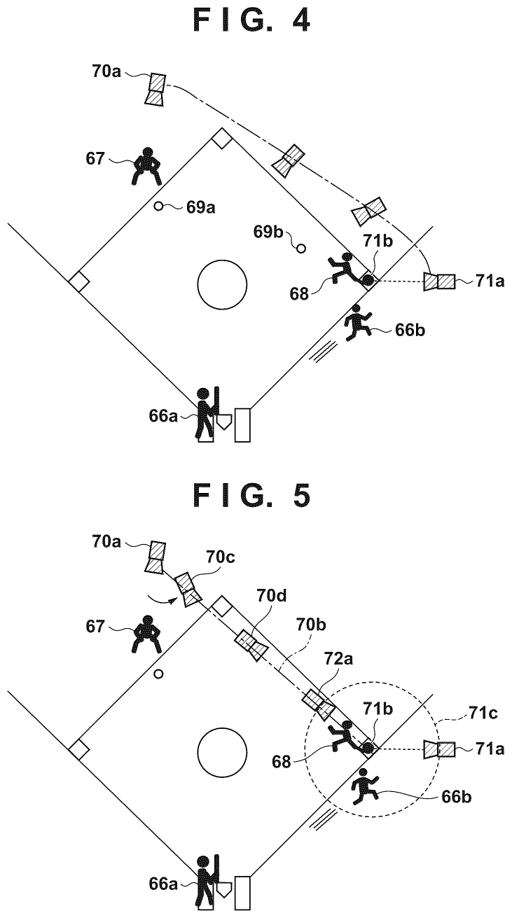

In the camera position preset mode, after the virtual camera has moved along the camera path, it is possible to obtain a virtual viewpoint video of an angle of view corresponding to the preset information registered in advance. On the other hand, there are cases where it is desired to control the virtual camera by using different methods. FIG. 4 is a diagram for describing the preset operation of the virtual camera in another scene of a baseball game. In the scene shown in FIG. 4, after a fielder 67 catches a ball 69a hit by a batter 66a, the fielder 67 throws the ball toward another fielder 68 who is at the first base, and a batter 66b is running toward the first base at the same time. In FIG. 4, the batter 66a and the batter 66b represent the same player at different time points. Also, the ball 69a and a ball 69b present the same ball at different time points.

Camera position and orientation 70a shows the starting position and orientation of the virtual camera. The gaze point of the virtual camera located at the starting position is the position of the fielder 67. Upon the fielder 67 catching the ball and throwing the ball toward the first base, the user presses the preset key 54a. In this case, the virtual camera moves toward a position indicated by preset position and orientation 71a to capture images of the batter 66b and the ball 69b coming to the first base. However, in a case where the virtual camera is moved in accordance with the camera position preset mode described above, the ball 69 or the batter 66 may reach the first base before the virtual camera reaches the preset position. Also, the first base may not be included in the angle of view of the virtual camera that is moving, until the virtual camera comes close to the preset position. In this case, it may not be possible to obtain a virtual viewpoint video of a scene showing the batter 66 running through the first base or a scene showing the first baseman catching the ball. Also, it may not be possible to obtain a virtual viewpoint video showing which of the batter 66 and the ball 69 reaches the first base earlier than the other.

Therefore, the control terminal 150 according to the present embodiment can control the camera parameter of the virtual camera in accordance with the preset information by using a different method. As described above, in the present embodiment, the user selects a preset mode, and the control terminal 150 performs the preset operation in accordance with the selected preset mode. This configuration makes it easy to set a desired camera path. In one embodiment, the preset modes include the gaze point preset mode. The following describes a method in which the preset unit 153 sets a camera path of the virtual camera in accordance with the gaze point preset mode.

In the gaze point preset mode, the preset unit 153 obtains a second camera parameter indicating the position and orientation of the virtual camera. Then, the preset unit 153 performs control for changing the position and orientation of the virtual camera indicated by the second camera parameter based on the second camera parameter and a preset gaze point. In the present embodiment, the preset unit 153 performs this control by setting a camera path of the virtual camera based on the second camera parameter and the preset gaze point. FIG. 5 is a diagram for describing the preset operation and the camera path in the gaze point preset mode. FIG. 5 shows a scene of baseball similar to that shown in FIG. 4. As in FIG. 4, the camera position and orientation 70a shows the starting position and orientation of the virtual camera. The gaze point of the virtual camera located at the starting position is the position of the fielder 67. Upon the fielder 67 catching the ball and throwing the ball toward the first base, the user presses the preset key 54a.

At this time, the preset unit 153 obtains preset information corresponding to the preset key 54a from the preset recording unit 154. The preset information corresponding to the preset key 54a indicates the preset gaze point 71b of the virtual camera at the preset position and orientation 71a. In the present embodiment, the preset information indicates the position, orientation, and focal length of the virtual camera, and the preset gaze point 71b can be obtained based on these pieces of information. Then, the preset unit 153 sets a camera path of the virtual camera based on the starting position and starting orientation of the virtual camera and the preset gaze point 71b of the virtual camera indicated by the preset information corresponding to the preset key 54a.

The preset unit 153 can set the camera path such that the virtual camera moves from the starting position toward the preset gaze point. For example, the preset unit 153 can set the camera path of the virtual camera as described below.

In one embodiment, the preset unit 153 sets the camera path such that the virtual camera moves along a straight line connecting the starting position and the preset gaze point. For example, the preset unit 153 first calculates a straight line 70b connecting the starting position of the virtual camera indicated by the camera position and orientation 70a and the preset gaze point 71b. The preset unit 153 can set the camera path such that the virtual camera moves along the straight line 70b.

Also, the preset unit 153 can set the camera path such that the end point of the movement of the virtual camera is a point spaced apart from the gaze point. For example, the preset unit 153 can set the camera path such that the end point of the movement of the virtual camera is a point spaced apart from the gaze point by a predetermined distance. The predetermined distance may be the distance between the position of the virtual camera indicated by the camera parameter of the virtual camera that is preset in advance (i.e., the preset position) and the preset gaze point. Specifically, the preset unit 153 determines a point 72a of intersection between the straight line 70b described above and a preset spherical surface 71c whose center is the preset gaze point 71b. As described above, the distance between the preset gaze point and each point on the preset spherical surface is equal to the distance between the preset position and the preset gaze point. The thus calculated point 72a of intersection is used as the end point of the camera path. That is to say, the preset unit 153 can set the camera path such that the virtual camera moves from the starting position to the point 72a of intersection.

In the example shown in FIG. 5, the camera path is set such that the virtual camera moves along the straight line 70b from the starting position to the point 72a of intersection. The preset unit 153 can set the camera path such that the virtual camera moves from the starting position to the point 72a of intersection at a uniform speed.

Also, the preset unit 153 can set the orientation of the virtual camera during the movement. The preset unit 153 can set the camera path such that the virtual camera changes its orientation so as to face the preset gaze point while moving. In the example shown in FIG. 5, the preset unit 153 can control the orientation of the virtual camera moving along the camera path such that the virtual camera faces the preset gaze point 71b. Also, the preset unit 153 can set the camera path such that the virtual camera faces the preset gaze point 71b when located at the end point of the camera path.

As described above, the preset unit 153 can set the camera path such that the virtual camera moves from the starting position toward the preset gaze point. When the virtual camera moves in this manner, if the orientation of the virtual camera is changed toward the preset gaze point while the virtual camera is moving, the preset gaze point will be included in the angle of view of the virtual camera for a long period of time. Therefore, it is more unlikely to fail to obtain a video including desired scenes. Also, the preset unit 153 can set the camera path such that the end point of the movement of the virtual camera is a point spaced apart from the gaze point as described above. When the virtual camera moves in this manner, by changing the orientation of the virtual camera toward the preset gaze point while the virtual camera is moving, the entire subject that is present at the preset gaze point will be included in the angle of view of the virtual camera for a long period of time. This further reduces the possibility of failing to obtain a video including desired scenes.

In one embodiment, the virtual camera can rotate at a uniform speed so as to change its orientation from the orientation at the starting position to the orientation at the end point while moving from the starting position to the end point. In another embodiment, in the first half of the movement from the starting position to the end point, the virtual camera can rotate at a speed higher than a speed at which the virtual camera rotates in the second half of the movement. In still another embodiment, the preset unit 153 can set the camera path such that the virtual camera faces the preset gaze point while moving to the preset gaze point. Note that, in one embodiment, the wording “the virtual camera faces the preset gaze point” means that the preset gaze point is on the optical axis of the virtual camera. In the example shown in FIG. 5, the preset unit 153 can set the camera path such that the virtual camera faces the preset gaze point 71b on its way to the end point. For example, moving virtual cameras 70c and 70d shown in FIG. 5 are facing the preset gaze point 71b. Here, the preset unit 153 may set the camera path such that the virtual camera changes its orientation while moving, and faces the preset gaze point 71b on its way to the preset gaze point. Alternatively, the preset unit 153 may set the camera path such that the virtual camera starts to move from the starting position after changing its orientation toward the preset gaze point 71b. As described above, during the period of the movement from the starting position to the end point, it is possible to complete the change in the orientation of the virtual camera before the virtual camera reaches the end point. According to this configuration, the virtual camera moves to the end point on the preset spherical surface after being directed toward the first base in the example shown in FIG. 5. Therefore, it is more unlikely to fail to obtain a video including scenes that happen at the preset gaze point. Also, it becomes easier to create a virtual viewpoint video with a sense of presence.

In the camera position preset mode, the position and orientation of the virtual camera at the end point of the camera path are uniquely determined by the preset information irrespective of the starting position of the virtual camera. The camera position preset mode is effective when it is desired to move the virtual camera to a predetermined position to obtain a virtual viewpoint video of a predetermined angle of view, as in the case where a video taken from behind a batter is to be obtained. Also, the gaze point preset mode is effective when images of a series of play are captured, as in the case where images are captured so as to track a ball as described with reference to FIG. 5.

On the other hand, in the gaze point preset mode, the preset unit 153 can perform control such that the position and orientation of the virtual camera after the completion of the change are determined based on a second camera parameter and a first camera parameter. For example, the preset unit 153 can set the camera path such that the end point of the movement of the virtual camera in accordance with the camera path changes according to the starting position of the virtual camera and the position of the preset gaze point. Also, the preset unit 153 can set the camera path such that the orientation of the virtual camera at the end point of the camera path changes according to the starting position of the virtual camera and the position of the preset gaze point. The gaze point preset mode is also effective for targets of image capturing such as ball games other than baseball or sports other than ball games. For example, the gaze point preset mode is effective when a ball moves significantly, as in the case where the ball is crossed in front of a goal in soccer.

Note that the end point of the camera path may be determined on an XY plane. In this case, it is possible to define a preset circle whose center is at the preset gaze point and that passes the preset position by projecting the preset position and the preset gaze point onto the XY plane. Also, it is possible to determine a point of intersection between the preset circle and a path from the starting position of the virtual camera to the preset position by projecting the path onto the XY plane. In this case, it is possible to use XY coordinates of the determined point of intersection as XY coordinates of the end point of the camera path.

### Processing Flow

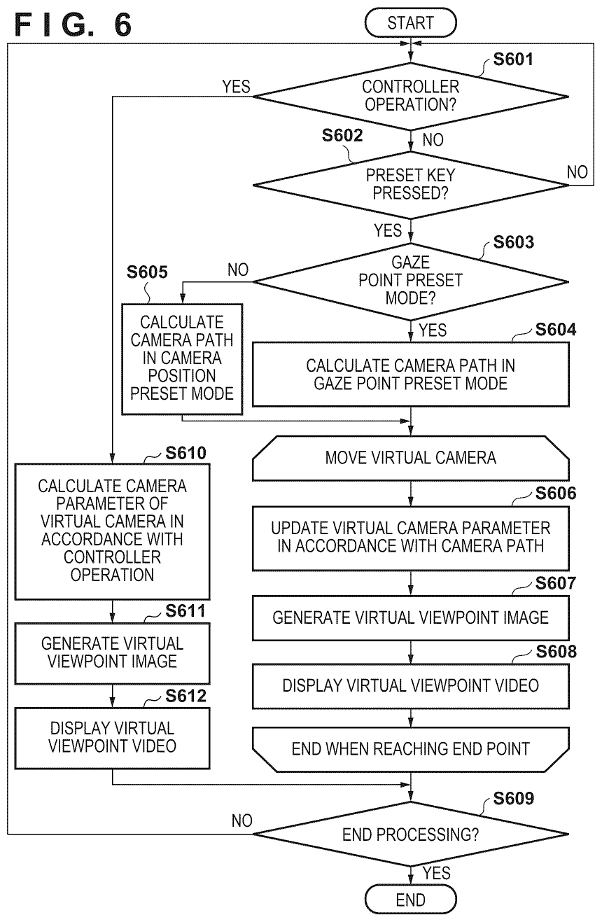

Next, the following describes a flow of processing performed by the virtual camera control device 105 in the present embodiment with reference to FIG. 6. FIG. 6 is a flowchart showing an example of operations performed by the virtual camera control device 105. When the following processing is performed, three-dimensional models of a subject corresponding to respective time points (time codes) are successively generated. Also, a virtual viewpoint video of the three-dimensional models of the subject, which is composed of frames corresponding to the respective time points, is displayed. The user can set the virtual camera while reproducing the virtual viewpoint video. However, the three-dimensional models of the subject corresponding to the respective time points may be generated in advance.

In step S601, the operation detecting unit 151 detects whether or not an operation for moving the virtual camera has been made with use of the operation controller 158a. In a case where the operation is detected by the operation detecting unit 151, the processing proceeds to step S610. Otherwise, the processing proceeds to step S602.

In step S602, the operation detecting unit 151 detects whether or not a preset key included in the setting controller 158b is pressed. In a case where pressing on a preset key is detected by the operation detecting unit 151, the processing proceeds to step S603. Otherwise, the processing returns to step S601, and the processing shown in FIG. 6 is continued.

In step S603, the preset unit 153 determines the current preset mode. In the present embodiment, the preset unit 153 determines whether the current preset mode is the gaze point preset mode or the camera position preset mode. In a case where it is determined that the current preset mode is the gaze point preset mode, the processing proceeds to step S604. In a case where it is determined that the current preset mode is the camera position preset mode, the processing proceeds to step S605.

In step S604, the preset unit 153 determines a camera path in the gaze point preset mode. The preset unit 153 determines the camera path based on the current position and orientation of the virtual camera and preset information corresponding to the pressed preset key by using the method described above.

In step S605, the preset unit 153 determines a camera path in the camera position preset mode. The preset unit 153 determines the camera path from the current position of the virtual camera to a preset position indicated by preset information corresponding to the pressed preset key by using the method described above.

In step S606, the parameter setting unit 152 updates the camera parameter of the virtual camera in accordance with the camera path set in step S604 or S605. Here, the parameter setting unit 152 can set the camera parameter of the virtual camera corresponding to a specific time point (time code). Then, the parameter setting unit 152 transmits the set camera parameter of the virtual camera via the information transmitting unit 157 to the video generating unit 143.

In step S607, the video generating unit 143 generates a virtual viewpoint video of the subject as viewed from the virtual camera based on the position and orientation of the virtual camera at each time point and a three-dimensional model of the subject corresponding to each time point. For example, the video generating unit 143 can generate the virtual viewpoint video in accordance with the received camera parameter of the virtual camera based on a three-dimensional model of the subject stored in the model DB 142. The video generating unit 143 can generate a frame image of the virtual viewpoint video corresponding to a specific time point (time code) with use of a three-dimensional model of the subject at the specific time point.

In step S608, the video generating unit 143 causes the video display 160 to display the generated virtual viewpoint video.

The processing in steps S606 to S608 is repeated until the virtual camera reaches the end point by moving along the camera path. That is to say, the parameter setting unit 152 can successively set camera parameters of the virtual camera at a plurality of time points by repeatedly performing the loop from step S606 to step S608. Then, the video generating unit 143 can successively generate virtual viewpoint images at the plurality of time points.

In step S609, the preset unit 153 determines whether or not to end the processing. For example, in a case where a power source switch (not shown) included in the setting controller 158b is operated or an end button (not shown) displayed on the operation UI is clicked, the preset unit 153 can determine to end the processing. In a case where it is determined to end the processing, the flow shown in FIG. 6 ends. In a case where it is determined not to end the processing, the processing returns to step S601, and the processing shown in FIG. 6 is repeated.

In step S610, the parameter setting unit 152 calculates a camera parameter of the virtual camera in accordance with the operation made on the operation controller 158a and detected in step S601. Here, the parameter setting unit 152 can set the camera parameter of the virtual camera of a specific time point (time code). Then, the parameter setting unit 152 transmits the set camera parameter of the virtual camera via the information transmitting unit 157 to the video generating unit 143.

In step S611, the video generating unit 143 generates a virtual viewpoint video in accordance with the received camera parameter of the virtual camera based on a three-dimensional model of the subject stored in the model DB 142, similarly to step S607. The video generating unit 143 can generate a frame image of the virtual viewpoint video corresponding to a specific time point (time code) with use of a three-dimensional model of the subject at the specific time point.

In step S612, the video generating unit 143 causes the video display 160 to display the generated virtual viewpoint video. Thereafter, the processing proceeds to step S609.

Note that, in a case where it is determined in step S601 and step S602 that no operation has been made on the controller 158, the video generating unit 143 can generate a frame image of a virtual viewpoint video similarly to step S611, although this is not shown in FIG. 6. In this case, the video generating unit 143 can generate the frame image of the virtual viewpoint video in accordance with the current camera parameter of the virtual camera with use of a three-dimensional model of the subject at a new specific time point. Similarly to step S612, the video generating unit 143 causes the video display 160 to display the generated virtual viewpoint video. That is to say, the virtual viewpoint video can be reproduced without moving the virtual camera.

As described above, the virtual camera control device according to the present embodiment can perform the preset operation corresponding to a preset mode in accordance with preset information. Also, in one embodiment, the user can change the preset mode. These configurations enable the user to generate a desired virtual viewpoint video with simple operations.

### Another Example of Setting of Camera Path in Gaze Point Preset Mode

The preset unit 153 may set a camera path different from those described above in the gaze point preset mode. For example, the preset unit 153 can set the camera path such that the virtual camera will not move in such a manner as to pass through a three-dimensional model of a subject. For example, in a case where there is another subject on a path of the virtual camera that is set using the above-described method, the preset unit 153 can generate a camera path by using the following method.

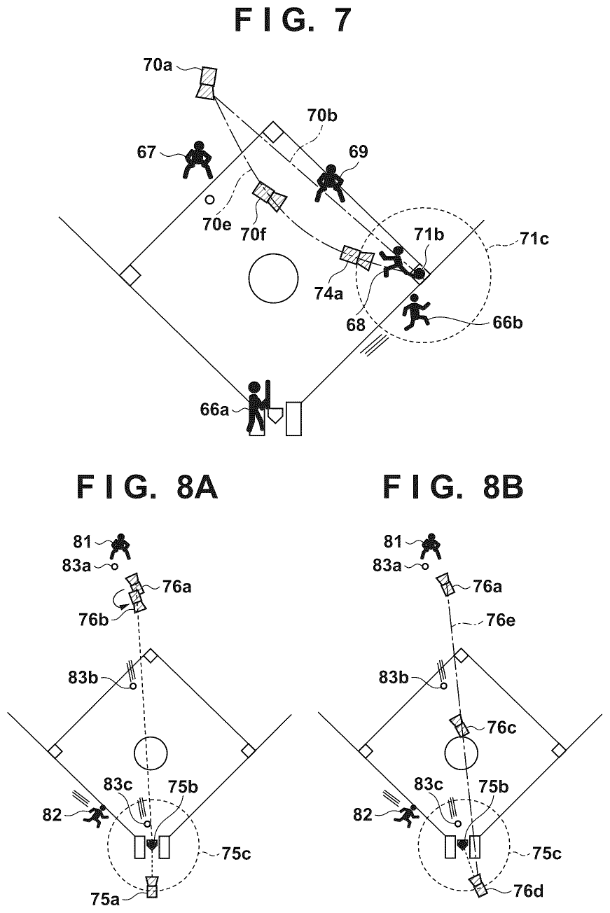

FIG. 7 is a diagram for describing another camera path in the gaze point preset mode. FIG. 7 shows a scene of baseball similar to that shown in FIG. 4. The scene shown in FIG. 7 differs from the scene shown in FIG. 4 in that a fielder 69 other than the fielders 67 and 68 is present on the path 70b shown in FIG. 4. In this case, the fielder 69 on the path 70b may be included in the angle of view of the virtual camera moving along the path 70b while changing its orientation toward the first base. In a case where there is an obstacle or a subject on the path 70b, which is the camera path, as described above, the preset unit 153 can set a camera path that makes a detour to avoid the obstacle or the subject. For example, the preset unit 153 can set a camera path shown as a path 70c. In a case where the virtual camera moves along the camera path shown as the path 70c, it is possible to suppress the occurrence of a situation in which the vicinity of the first base is hidden by the fielder 69 in a virtual viewpoint video.

In this case, the orientation of the virtual camera can be changed toward the preset gaze point immediately after the virtual camera starts to move along the camera path. Also, as shown by camera position and orientation 70f, the orientation of the virtual camera can be adjusted such that the virtual camera faces the preset gaze point 71b while moving along the camera path shown as the path 70c. In this example, the end point of the camera path is a point of intersection between the path 70e and the preset spherical surface 71c.

In one embodiment, the preset unit 153 can determine whether or not there is a three-dimensional model of a subject within a predetermined range from a straight line connecting the starting position and the preset gaze point. For example, the preset unit 153 can determine whether or not there is an obstacle or a subject to be avoided, based on whether or not there is a three-dimensional model of a subject as the foreground within the predetermined range from the path 70b in the virtual space in which three-dimensional models are disposed. The predetermined range can be set between the starting position of the virtual camera indicated by the camera position and orientation 70a and the preset spherical surface 71c, for example.

In a case where there is no three-dimensional model of a subject within the predetermined range, the preset unit 153 can set a camera path like the path 70b such that the virtual camera moves along the straight line connecting the starting position and the gaze point. On the other hand, in a case where there is a three-dimensional model of a subject within the predetermined range, the preset unit 153 can set a camera path such that the virtual camera moves along a route that connects the starting position and the preset gaze point, making a detour to avoid the three-dimensional model of the subject. For example, in a case where there is a three-dimensional model within the predetermined range from the path 70b, the preset unit 153 can set a curved line that does not pass through a range of a certain size having its center at the three-dimensional model. The curved line is a curved line extending from the current position of the virtual camera to the preset gaze point, and may be an arc, for example. Note that, in the example shown in FIG. 7, the preset unit 153 generates the path 70e avoiding the fielder 69, which is an obstacle, by shifting the path 70b in the XY directions. However, the preset unit 153 may also generate a camera path such that the virtual camera moves in the Z direction to avoid the obstacle.

Irrespective of whether the virtual camera moves along a straight line or a curved line, the preset unit 153 can set a camera path such that the end point of the movement of the virtual camera in accordance with the camera path is closer to the starting position of the virtual camera than the preset gaze point is. When the virtual camera moves in this manner, by changing the orientation of the virtual camera toward the preset gaze point while the virtual camera is moving, the preset gaze point will be included in the angle of view of the virtual camera for a long period of time. Therefore, it is more unlikely to fail to obtain a video including desired scenes.

### Other Preset Modes

Preset modes that can be selected by the user are not limited to the gaze point preset mode and the camera position preset mode described above. The following describes an orientation change preset mode and a position change preset mode as other examples of preset modes that can be selected by the user.

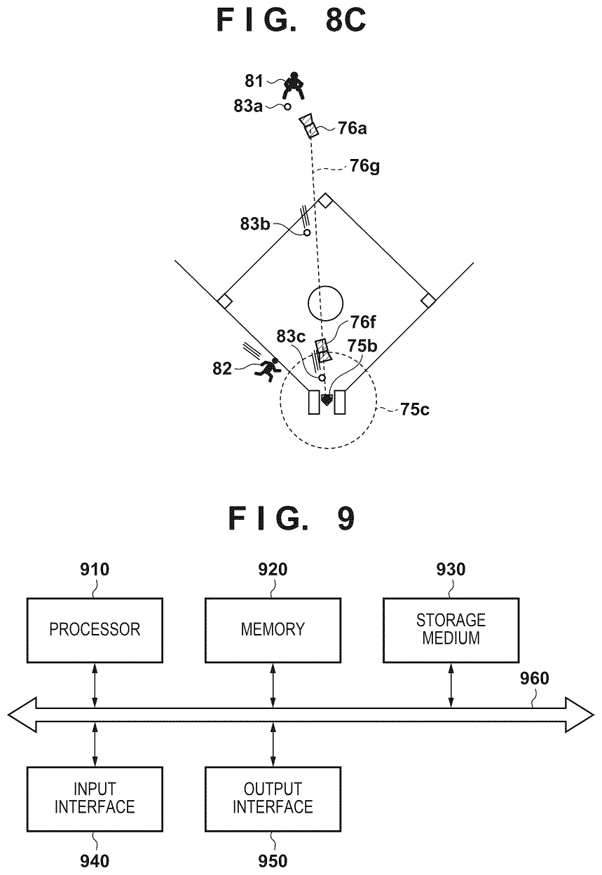

The following describes methods for setting a camera path in the respective preset modes with reference to FIGS. 8A to 8C. FIGS. 8A to 8C show a scene in which an outfielder 81 catches a ball 83a and then throws the ball toward the home base, and a runner 82 is running toward the home base. The ball 83a reaches the home base via positions 83b and 83c. Balls 83a to 83c represent the same ball at different time points. In this example, preset position and orientation shown by preset position and orientation 75a is behind the home base. Also, a preset gaze point 75b is set to the vicinity of the home base. On the other hand, starting position and orientation of the virtual camera is shown by camera position and orientation 76a. The gaze point at the camera position and orientation 76a is at the outfielder 81. In response to the user pressing a preset key 54 upon the outfielder 81 throwing the ball 83 toward the home base, the preset unit 153 sets a camera path.

The following describes setting of a camera path in the orientation change preset mode with reference to FIG. 8A. In the orientation change preset mode, the preset unit 153 sets the camera path such that the virtual camera changes its orientation toward the preset gaze point without moving from the starting position.

In FIG. 8A, the starting position of the virtual camera is shown by the camera position and orientation 76a. In the orientation change preset mode, the preset unit 153 sets a camera path for changing only the orientation of the virtual camera toward the preset gaze point 75b without changing the position of the virtual camera. In FIG. 8A, the end point of the camera path is shown by camera position and orientation 76b. In FIG. 8A, the position shown by the camera position and orientation 76b is slightly shifted from the position shown by the camera position and orientation 76a for the sake of convenience of description, but actually, only the orientation and gaze point of the virtual camera are changed without the position of the virtual camera being changed. In a case where the virtual camera is moved along such a camera path, it is possible to generate a virtual viewpoint video in which the ball reaching the home base is viewed from the outfielder. Note that, in the orientation change preset mode, the camera parameter of the virtual camera may be controlled such that the focal length gradually increases.

Next, the following describes setting of a camera path in the position change preset mode with reference to FIG. 8B. In FIG. 8B as well, the starting position of the virtual camera is shown by the camera position and orientation 76a. In the position change preset mode, the preset unit 153 sets the camera path such that the virtual camera does not change its orientation from the starting orientation and faces the gaze point when located at the end point of the movement of the virtual camera in accordance with the camera path.

For example, the preset unit 153 can set the camera path such that the virtual camera moves from the position shown by the camera position and orientation 76a to the position shown by camera position and orientation 76d without changing its orientation. For example, the preset unit 153 can set the camera path such that the virtual camera moves at a uniform speed along a path 76e that is shown as a line segment extending from the position shown by the camera position and orientation 76a to the position shown by the camera position and orientation 76d. As shown by camera position and orientation 76c, the virtual camera moves without changing its orientation. The camera position and orientation 76d showing the end point of the camera path is set such that the orientation of the virtual camera matches the starting orientation and the gaze point of the virtual camera is at the preset gaze point 75b. That is to say, the position shown by the camera position and orientation 76d is located on a preset spherical surface 75c.

FIG. 8C shows a method for setting a camera path in the gaze point preset mode. The camera path is set in the gaze point preset mode as described above. In the example shown in FIG. 8C, camera position and orientation 76f shows the position and orientation of the virtual camera at the end point of the camera path. In this example, the virtual camera can move at a uniform speed along a path 76g from the position shown by the camera position and orientation 76a to the position shown by the camera position and orientation 76f. On the other hand, the orientation of the virtual camera can be changed toward the preset gaze point 75b immediately after the start of the preset operation.

As described above, the preset unit 153 may set a camera path for changing only the orientation or position of the camera based on preset information. With use of these preset modes, the user can create various free viewpoint videos with simple operations.

After the preset operation, the parameter setting unit 152 can control the camera parameter of the virtual camera in accordance with user input. At this time, restrictions may be imposed on the position or orientation of the virtual camera. For example, the operation detecting unit 151 may obtain user input for moving the virtual camera along a straight line connecting the starting position and the preset gaze point of the virtual camera while fixing the orientation of the virtual camera in the state where the virtual camera faces the preset gaze point. For example, after the orientation of the virtual camera is changed toward the preset gaze point in the orientation change preset mode, the virtual camera may be moved to be closer to the preset gaze point in accordance with a user instruction made via the operation controller 158a. Also, the parameter setting unit 152 may automatically change the orientation of the virtual camera such that the virtual camera always faces the preset gaze point even when the virtual camera is moved in response to a user operation in the state where the virtual camera faces the preset gaze point.

As already described above, the user can switch the preset mode. The user can operate the mode keys 53 to switch the preset mode. On the other hand, the user can press a combination of a mode key 53 and a preset key 54 to start the preset operation. As described above, preset modes are respectively set for the plurality of mode keys 53. Also, camera parameters of the virtual camera are respectively set for the plurality of preset keys 54. The user can press a combination of a mode key 53 corresponding to the selected preset mode among the plurality of mode keys 53 and a preset key 54 corresponding to the selected camera parameter among the plurality of preset keys 54. At this time, the preset unit 153 can set a camera path based on the preset mode corresponding to the pressed mode key and the camera parameter of the virtual camera corresponding to the pressed preset key.

For example, the camera position and orientation 75a at which the gaze point is in the vicinity of the home base may be registered for the preset key 54a. In this case, the preset position and orientation 75a, the gaze point 75b, and the radius of the preset spherical surface 75c can be registered as preset information corresponding to the preset key 54a. Also, the camera position preset mode can be registered for the mode key 53a. The orientation change preset mode can be registered for the mode key 53b. The position change preset mode can be registered for the mode key 53c. The user can start preset operation corresponding to a preset mode and preset information by pressing any of the mode keys 53 and any of the preset keys 54 at the same time.

For example, in response to the user pressing the preset key 54a together with the mode key 53b, the preset unit 153 sets a camera path in accordance with the orientation change preset mode as described with reference to FIG. 8A. Also, in response to the user pressing the preset key 54a together with the mode key 53c, the preset unit 153 sets a camera path in accordance with the position change preset mode as described with reference to FIG. 8B. Furthermore, in response to the user pressing the preset key 54a together with the mode keys 53b and 53c, the preset unit 153 sets a camera path in accordance with the gaze point preset mode as described with reference to FIG. 8C. Note that the gaze point preset mode may be registered for the mode key 53d.

### Variations

In the above embodiment, the camera parameter of the virtual camera includes information of the position, orientation, and focal length of the virtual camera. However, when the position, orientation, and focal length of the virtual camera are determined, for example, the gaze point and the distance from the virtual camera to the gaze point can be determined using the methods described above. Likewise, it is possible to determine the orientation and focal length of the virtual camera and the distance from the position of the virtual camera to the gaze point based on the position and gaze point of the virtual camera. That is to say, when some parameters are determined, the other parameters can be calculated. In other words, the parameters have a complementary relationship. Therefore, the camera parameter of the virtual camera may include information of the position and gaze point of the virtual camera. Alternatively, the camera parameter of the virtual camera may include information of the position, orientation, and focal length of the virtual camera. As described above, the camera parameter of the virtual camera includes one or more of the position of the virtual camera, the orientation of the virtual camera, the focal length of the virtual camera, the gaze point of the virtual camera, and the distance from the position of the virtual camera to the gaze point.

In one embodiment, the camera parameter of the virtual camera is information based on which it is possible to calculate at least the position, orientation, and gaze point of the virtual camera. Such information can be said to be information indicating the position, orientation, and gaze point of the virtual camera. For example, information indicating the position and gaze point of the virtual camera can be said to be information indicating the position, orientation, and gaze point of the virtual camera.

In the above embodiment, the gaze point of the virtual camera is information that can be calculated based on the position, orientation, and focal length of the virtual camera. However, the method for determining the gaze point is not limited to this method. For example, the gaze point may be set irrespective of the focal length. For example, the gaze point of the virtual camera may be set by the user. Alternatively, the gaze point of the virtual camera may be a point that is on the optical axis of the virtual camera and spaced apart from the virtual camera by a predetermined distance. Furthermore, the gaze point of the virtual camera may be set to the position of a three-dimensional model of a subject (e.g., a base) that is on the optical axis of the virtual camera. In this case, the gaze point of the virtual camera can be calculated based on the position and orientation of the virtual camera. That is to say, in one embodiment, the camera parameter of the virtual camera may be information indicating the position and orientation of the virtual camera. On the other hand, the camera parameter of the virtual camera may include other information.

Likewise, preset information may also be information similar to the camera parameter of the virtual camera. The preset information can indicate the orientation of the virtual camera and the position of a gaze point corresponding to the virtual camera. In the above embodiment, the preset information includes a position and an orientation of the virtual camera that are preset and the radius of a preset spherical surface (i.e., the distance from the preset position to the preset gaze point). On the other hand, the preset information may also include information indicating the orientation of the virtual camera and information indicating the position of the gaze point. For example, the preset information may include information indicating the orientation of the virtual camera, information indicating the position of the gaze point, and information indicating the distance between the virtual camera and the gaze point. Alternatively, the preset information may also include the preset position of the virtual camera, the position of the preset gaze point, and information indicating the radius of the preset spherical surface. Here, the information indicating the radius of the preset spherical surface may be the focal length or may be set irrespective of the focal length. Alternatively, the preset information may indicate only the preset position of the virtual camera and the preset gaze point. Alternatively, the preset information may indicate only the preset position and orientation of the virtual camera. Based on these pieces of preset information, it is possible to calculate the preset position, orientation, and gaze point of the virtual camera as described above. On the other hand, the preset information may include information of other camera parameters.

In the above embodiment, the virtual camera control device 105 mainly controls the position and orientation of the virtual camera at each time point. However, the virtual camera control device 105 may also generate a camera path to control camera parameters other than the position and orientation of the virtual camera.

In the above embodiment, the user can select a desired preset mode from the plurality of preset modes. However, it is not essential that the user can select the preset mode. For example, the virtual camera control device 105 may perform the preset operation in accordance with only one of the gaze point preset mode, the position change preset mode, and the orientation change preset mode.

In the gaze point preset mode, the position change preset mode, and the orientation change preset mode, the preset operation can be performed based on the starting position and starting orientation of a virtual viewpoint and the preset gaze point. In this preset operation, it is not necessary to use the preset position and orientation. Therefore, it is also possible to register only information of the preset gaze point as preset information for each preset key. For example, a configuration is also possible in which the user registers only preset information for the gaze point preset mode. In this case, the user can select the gaze point to be registered and further input the radius of the preset spherical surface, on a UI displayed on the operation display 159. In this case, only the gaze point and the radius of the preset spherical surface are registered as the preset information. However, in the gaze point preset mode, the preset operation can be performed based on only these pieces of information.

Each device shown in FIG. 2B can be realized with use of a computer. Examples of the computer include a general-purpose desktop computer, a laptop computer, a tablet PC, and a smartphone. For example, functions of processing units included in each device shown in FIG. 2B can be realized by the computer. However, at least some of the processing units may also be realized by dedicated hardware. Also, each device may be constituted by a plurality of information processing devices connected to each other via a network, for example. For example, functions of each image processing device may be provided as a cloud service. Furthermore, one computer may realize functions of two or more devices shown in FIG. 2B.

FIG. 9 is a diagram showing a basic configuration of the computer. In FIG. 9, a processor 910 is, for example, a CPU and controls operations of the entire computer. A memory 920 is, for example, a RAM and temporarily stores programs, data, and the like. A computer-readable storage medium 930 is, for example, a hard disk or a CD-ROM and stores programs, data, and the like for a long period of time. In the present embodiment, a program for realizing functions of the respective units, which is stored in the storage medium 930, is read into the memory 920. Then, the processor 910 operates in accordance with the program in the memory 920, and thus the functions of the respective units are realized.

In FIG. 9, an input interface 940 is an interface for obtaining information from an external device. Also, an output interface 950 is an interface for outputting information to an external device. A bus 960 connects the above-described units to enable data exchange therebetween.

One embodiment of the present disclosure makes it easy to obtain a desired virtual viewpoint video with simple operations when controlling a virtual camera disposed in a virtual space to generate the virtual viewpoint video.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122553, filed Jul. 29, 2024, which is hereby incorporated by reference herein in its entirety.

What is claimed is:

1. An information processing system for controlling a virtual camera disposed in a virtual space to generate a virtual viewpoint video, the information processing system comprising one or more memories storing instructions and one or more processors that execute the instructions to:
obtain a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and
perform control for changing the position and orientation of the virtual camera indicated by the second camera parameter based on the second camera parameter and the first camera parameter,
wherein the position and orientation of the virtual camera after completion of the change are determined based on the second camera parameter and the first camera parameter.

2. The information processing system according to claim 1,
wherein the gaze point is a point spaced apart from the virtual camera disposed in accordance with the first camera parameter by a distance corresponding to a focal length indicated by the first camera parameter along a direction of line of sight.

3. The information processing system according to claim 1, wherein the one or more processors execute the instructions to:
perform the control such that the virtual camera moves while changing the orientation toward the gaze point.

4. The information processing system according to claim 1, wherein the one or more processors execute the instructions to:
perform the control such that the virtual camera faces the gaze point while moving.

5. The information processing system according to claim 1, wherein the one or more processors execute the instructions to:
perform the control such that the virtual camera moves from the position indicated by the second camera parameter toward the gaze point.

6. The information processing system according to claim 5, wherein the one or more processors execute the instructions to:
perform the control such that the virtual camera moves along a straight line connecting the position indicated by the second camera parameter and the gaze point.

7. The information processing system according to claim 5, wherein the one or more processors execute the instructions to:
determine whether or not there is a three-dimensional model of a subject within a predetermined range from a straight line connecting the position indicated by the second camera parameter and the gaze point;
in a case where there is no three-dimensional model of a subject within the predetermined range, perform the control such that the virtual camera moves along the straight line connecting the position indicated by the second camera parameter and the gaze point; and
in a case where there is a three-dimensional model of a subject within the predetermined range, perform the control such that the virtual camera moves along a route connecting the position indicated by the second camera parameter and the gaze point, making a detour to avoid the three-dimensional model of the subject.

8. The information processing system according to claim 5, wherein the one or more processors execute the instructions to:
perform the control such that an end point of the movement of the virtual camera is a point spaced apart from the gaze point.

9. The information processing system according to claim 5, wherein the one or more processors execute the instructions to:
perform the control such that an end point of the movement of the virtual camera is a point spaced apart from the gaze point by a predetermined distance, the predetermined distance being a distance between a position of the virtual camera indicated by the first camera parameter and the gaze point.

10. The information processing system according to claim 1, wherein the one or more processors execute the instructions to:
perform the control such that an end point of the movement of the virtual camera changes according to the position indicated by the second camera parameter and the position of the gaze point.

11. The information processing system according to claim 1, wherein the one or more processors execute the instructions to:
perform the control such that an end point of the movement of the virtual camera is closer to the position indicated by the second camera parameter than the gaze point is.

12. The information processing system according to claim 1, wherein the one or more processors execute the instructions to:
perform the control such that the virtual camera changes the orientation toward the gaze point without moving from the position indicated by the second camera parameter.

13. The information processing system according to claim 12, wherein the one or more processors execute the instructions to:
obtain user input for moving the virtual camera along a straight line connecting the position indicated by the second camera parameter and the gaze point while fixing the orientation of the virtual camera after the virtual camera changes the orientation toward the gaze point.

14. The information processing system according to claim 1, wherein the one or more processors execute the instructions to:
perform the control such that the virtual camera does not change the orientation from the orientation indicated by the second camera parameter, and faces the gaze point at an end point of the movement of the virtual camera.

15. The information processing system according to claim 1, wherein the one or more processors execute the instructions to:
obtain user input indicating a preset mode that is selected from a plurality of preset modes,
perform the control in accordance with the preset mode indicated by the user input,
wherein the plurality of preset modes include:
a first preset mode in which the control is performed based on the position and orientation indicated by the second camera parameter and the gaze point of the virtual camera indicated by the first camera parameter; and
a second preset mode in which the control is performed such that an end point of the movement of the virtual camera is a position of the virtual camera indicated by the first camera parameter.

16. The information processing system according to claim 15,
wherein the user input is made by pressing a combination of a mode key among a plurality of mode keys for which preset modes are respectively set and a preset key among a plurality of preset keys for which camera parameters of the virtual camera are respectively set, and
the control is performed based on a preset mode corresponding to the pressed mode key and a camera parameter of the virtual camera corresponding to the pressed preset key.

17. The information processing system according to claim 1, wherein the one or more processors execute the instructions to:
set a position and an orientation of the virtual camera at each time point in accordance with the control; and
generate a virtual viewpoint video of a subject as viewed from the virtual camera based on the position and orientation of the virtual camera at each time point and a three-dimensional model of the subject corresponding to each time point.

18. The information processing system according to claim 17, further comprising a plurality of cameras,
wherein the one or more processors execute the instructions to generate a three-dimensional model of the subject based on images captured by the plurality of cameras.

19. An information processing method for controlling a virtual camera disposed in a virtual space to generate a virtual viewpoint video, comprising:
obtaining a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and
performing control for changing the position and orientation of the virtual camera indicated by the second camera parameter based on the second camera parameter and the first camera parameter,
wherein the position and orientation of the virtual camera after completion of the change are determined based on the second camera parameter and the first camera parameter.

20. A non-transitory computer-readable medium storing a program executable by a computer to perform a method for controlling a virtual camera disposed in a virtual space to generate a virtual viewpoint video, comprising:
obtaining a second camera parameter that is different from a first camera parameter and indicates a position and an orientation of the virtual camera, wherein the first camera parameter is set in advance, stored in a storage, and indicates an orientation of the virtual camera and a position of a gaze point corresponding to the virtual camera; and
performing control for changing the position and orientation of the virtual camera indicated by the second camera parameter based on the second camera parameter and the first camera parameter,
wherein the position and orientation of the virtual camera after completion of the change are determined based on the second camera parameter and the first camera parameter.
